(19) United States
(12) Patent Application Publication
(10) Pub. No.: US 2024/0320725 A1
(43) Pub. Date: Sep. 26, 2024

(54) FACTORING SYSTEM AND METHOD

(71) Applicant: FACTOR-e, Inc., Los Angeles, CA (US)

(72) Inventors: Leonard Jackson, Valencia, CA (US); Alexander Tsao, Los Angeles, CA (US)

(73) Assignee: FACTOR-e, Inc., Los Angeles, CA (US)

(21) Appl. No.: 18/612,743

(22) Filed: Mar. 21, 2024

Related U.S. Application Data
(60) Provisional application No. 63/453,618, filed on Mar. 21, 2023.

(51) Int. Cl. G06Q 30/0601; G06Q 30/04

(52) U.S. Cl. CPC G06Q 30/0619; G06Q 30/04

(57) ABSTRACT

A factoring system and method in the form of an online marketplace for invoice factoring services enables invoice sellers to create business and invoice profiles and solicit factoring companies to submit proposals. Factoring companies can shop invoice seller profiles and determine whom they wish to make proposals to. The system and method of the present invention enables legal documents to be automatically created and signed/stored by the parties to an engagement.

### RELATED APPLICATIONS

This application claims the benefit of U.S. Provisional Application No. 63/453,618 filed on Mar. 21, 2023.

### BACKGROUND OF THE INVENTION

An invoice reflects the payment owed by a customer after a service provider has been engaged to, and has completed, service under the terms of the parties' transaction agreement. For example, in the context of the freight transportation/shipping industry, a freight invoice would be generated once a bill of lading is signed off by the receiving party, once a carrier delivers a load as part of the shipping process. This verification of delivery creates a payment responsibility for the invoice customer/shipper based on the delivery of goods. Such responsibility includes the obligation of the invoice customer to pay the carrier/broker or its assignee for transporting the requested cargo/goods.

Unfortunately, even after the freight invoice is generated, it can still take weeks or months for the trucking company or carrier owner to receive payment due to contractual lead times, amongst other things. Factoring companies exist to close the financial gap between completing a load delivery and getting paid for such transaction. Factoring is thus a normal business procedure in the trucking industry, as well as in other industries that also deal with contractual lead times after infrastructure costs have been expended to complete the underlying commercial transaction, such as in construction, employment staffing, manufacturing, and apparel/garment assembly. Factoring is a way for service providers to receive operationally critical, expedited payment for their completed service transactions, and the invoices related thereto.

Factoring is a process where the service provider, i.e., the carrier in the context of freight and transportation services, sells its invoice to a company that specializes in invoice financing, as well as the collection and processing of accounts receivable (A/R). In exchange for its financial and administrative services, the factoring company collects a percentage of the invoice amount as a fee; which percentage amount is reflected in the amount advanced to the seller in exchange for the rights/entitlements under the invoice. Thus, instead of the seller collecting on, and processing, the account receivable invoice, the factoring company takes over this administrative task for a discounted advance rate/purchase price on the invoice itself, and the seller assigns the relevant right to payment under the invoice to the factoring company. For example, a factoring company may purchase the payment rights under a carrier's open invoice, which is unpaid due to contractual lead times, by advancing a discounted rate, such as 95% of the invoice amount. The carrier is thereby able to have immediate cash flow without having to wait weeks or months for payment on the relevant invoice, allowing it to continue operating its business.

There are two types of factoring, namely, recourse and non-recourse factoring. Factoring companies that offer recourse factoring services take a lower percentage of the invoice amount as their transaction fee when purchasing the unpaid invoices. However, if the factoring company is unable to collect payment from the customer within a predefined period of time, the invoice seller is required to repurchase the invoice. In non-recourse factoring, if the invoice customer does not pay on the applicable invoice, the invoice seller will not be held liable for repayment or repurchase. However, with non-recourse factoring services, the factoring company buyer will take a substantially larger percentage of the invoice amount as part of its service fee.

Previously, industry participants had to actively cold call potential invoice sellers or factoring companies to speak with one or more representatives in order to obtain initial factoring service information or factoring service needs. Then the industry participant would need to follow up after internal discussion, just to have one or more phone calls or in-person meetings to discuss the potential terms of a factoring engagement. From there, after a possibly extended negotiation period, terms are orally agreed to, and then legal documents necessary to formalize the engagement are drafted, sent, reviewed, and possibly executed-potentially taking days or weeks depending on how many items/terms are negotiated.

After the parties have created an active factoring engagement and when an invoice meeting the terms of the parties' engagement is eligible, the carrier will notify the factoring company, tender the invoice, which will be the subject to manual review by the factoring company, and an advance may be submitted by the company according to the parties' agreement. After the advance is paid, the parties track the aging of the invoice to ensure it does not exceed the maximum period set forth in the parties' agreement, and upon payment by the invoice customer to the factoring company, the carrier's reserves within that given transaction should be credited or submitted back to the carrier, when and if one or more of the parties realize that there is a valid reserve amount to be disbursed.

Thus, the current factoring process is complicated due to the significant amount of time it takes to identify and conduct diligence on factoring companies, enter into factoring relationships and agreements with the identified companies, and track invoice aging and account reserves on any submitted invoice. Accordingly, there is a continuing need for a system and method to improve and streamline this process. The present invention fulfills these needs, and provides other related advantages.

### SUMMARY OF THE INVENTION

The present invention is directed to a computerized, online marketplace for invoice factoring services. The online marketplace overcomes many of the drawbacks associated with the current practice of manually finding, manually conducting due diligence for, engaging in extended negotiations on, and managing ongoing factoring services and transactions.

A process for invoice factoring, in accordance with the present invention, generally comprises the steps of providing a computerized factoring marketplace. A factoring company accesses the factoring marketplace via an electronic network using a computerized device and creates an account, including an invoice seller profile, and requests a factoring proposal. The factoring company reviews the request for factoring proposal through the factoring marketplace and creates a digital factoring proposal sent to the invoice seller through the computerized factoring marketplace. The invoice seller and the factoring company agree to a factoring arrangement, and the one or more factored invoices subject to the factoring agreement are tracked, via the factoring marketplace, including the status, payment, and/or ageing.

The invoice seller and the factoring company communicate and negotiate the terms of the factoring arrangement through the computerized factoring marketplace. The system and process of the present invention may automatically generate at least one legal document which is accessible by the factoring company and invoice seller through the computerized factoring marketplace, relating to the agreed-to factoring arrangement between the factoring company and the invoice seller. The at least one legal document may be automatically generated by auto-populating a financial disclosure form based on information provided by the factoring company and/or invoice seller. The invoice seller and the factoring company may execute the at least one legal document with digital signatures through the computerized factoring marketplace.

The invoice seller, when creating an account, may input factoring service requirements of the invoice seller for review by potential factoring companies. A plurality of factoring companies may each create digital proposals and the invoice seller may review and select a factoring company proposal through the computerized factoring marketplace which it desires or best suits its needs. The invoice seller may upload one or more digital invoices and the factoring company may determine whether to approve one or more of the digital invoices for financing.

The tracking step may include the step of updating, in real time, factored invoice transactions or deadlines and automatically notifying the factoring company and invoice seller of updates. A digital dashboard may be provided for each factoring company and invoice seller that enables access to transaction data related to factored invoices and factoring arrangements.

A customer, which received goods or services subject to the factored invoice, may access the computerized factoring marketplace via an electronic network using a computerized device to review the factored invoice, and communicate with the factoring company and/or pay the factored invoice. A payment system may be made accessible by the factoring company, invoice seller, and customer can make payments on the factored invoice or factoring arrangement and to provide payment notifications.

Under a recourse arrangement between the invoice seller and the factoring company, a factoring purchase price may be automatically refunded to the factoring company if the factored invoice is not paid after a predetermined period of time.

The present invention may provide digital dispute resolution between the invoice seller and the factoring company through the computerized factoring marketplace.

Third parties may be allowed to offer goods or services to the invoice seller or factoring company through the computerized factoring marketplace.

A reliability score for the invoice seller and/or factoring company may be generated, such as being automatically generated using artificial intelligence or the like.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a diagrammatic view of a computerized marketplace and network used in accordance with the present invention;

FIG. 2 is an illustration of an exemplary sign-in screen, used in accordance with the present invention;

FIG. 3 is a diagrammatic view of a screen for creating an account, in accordance with the present invention;

FIG. 4 is a flow chart depicting steps taken in accordance with the present invention;

FIGS. 5-10 are diagrammatic views of dashboards used by participants of the invention;

FIG. 11 is a diagrammatic view illustrating a computerized window used to create a new invoice, in accordance with the present invention;

FIG. 12 is a diagrammatic view of an invoice listing of a dashboard used by participants, in accordance with the present invention; and

FIGS. 13 and 14 are diagrammatic views of aspects of a participant dashboard, used in accordance with the present invention.

### DETAILED DESCRIPTION OF THE PREFERRED EMBODIMENTS

As shown in the accompanying drawings, for purposes of illustration, the present invention resides in a factoring system and method. The factoring system and method is embodied within a computerized online marketplace. The system and method of the present invention allows invoice holders (e.g., freight transportation/logistics operators, trucking companies, construction companies, employment staffing organizations, manufacturing activities, apparel/garment assembly offices, etc.) to shop for factoring services and sell their invoices. Additionally, the system and method of the present invention allows factoring companies to find and conduct due diligence on new clients. The present invention also allows customers, such as those who owe on an invoice or are seeking goods or services, to access the computerized marketplace of the present invention and obtain such goods or services and/or pay their outstanding invoices.

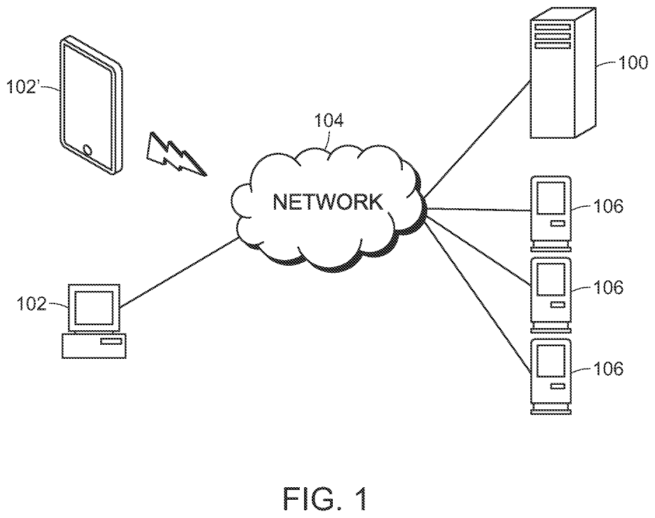

With reference now to FIG. 1, the system of the present invention is embodied on a computerized marketplace 100, which may be on one or more server computers, cloud servers, or even a serverless network or offered as software as a service or the like. Invoice sellers, such as a transportation professional, access the online computerized marketplace 100 utilizing their computerized digital device, such as in the form of a desktop computer 102, a portable computer 102, such as a laptop, tablet, or cell phone. The invoice selling user member, e.g., a freight professional, through its computer 102, accesses the online marketplace 100 through an electronic network 104, such as the internet. Factoring companies access the online marketplace 100 through the network 104 via their own computerized devices 106. After setting up accounts and gaining membership or access to the online marketplace 100, the invoice seller/user members and factoring companies, as well as others, such as peripheral product/service companies, insurance providers, etc. may view information relating to the identity of members of the online marketplace 100 housed on the server 100 and can conduct business in accordance with the present invention.

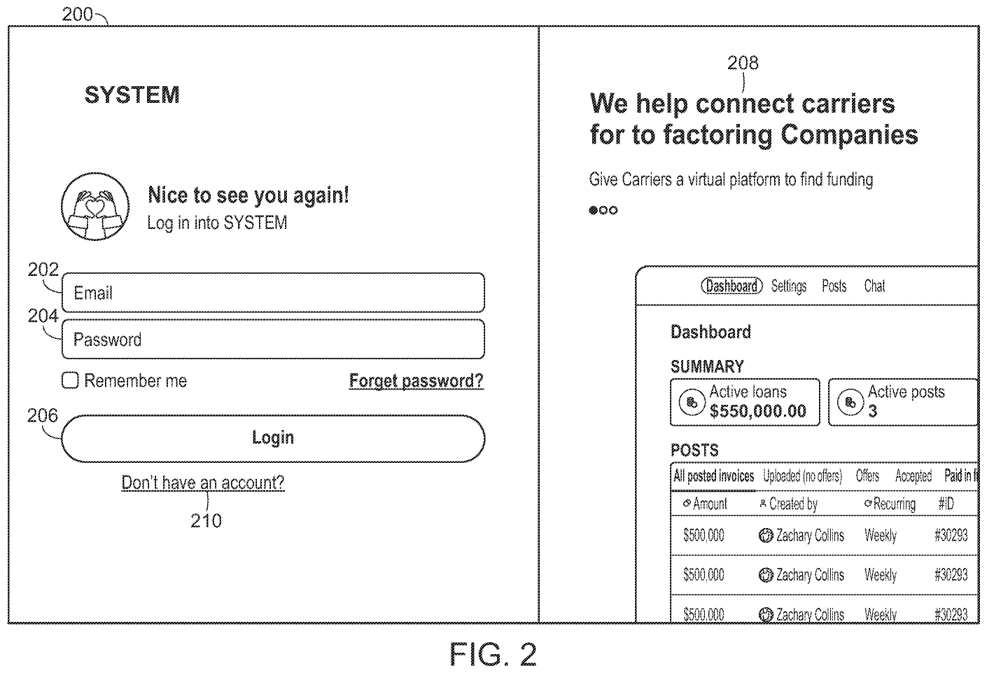

With reference now to FIG. 2, when accessing the system of the present invention, such as via a website or other network or via a web mobile application, a login page 200 is displayed. Prompts are provided for the member or potential user of the system to log into the system, such as including an email 202 and password 204. Other login identifiers may be used, such as a user name, etc. In the event that the member or user, who has already created an account, has forgot his or her password, a link may be provided to another page such that the user's password can either forwarded to him or her or be reset. The user may then depress a digital button 206 to log in. A screen 200 may include additional information, graphics, or the like 208 to inform a first time user or visitor to the website of the functions and features that the system and process of the present invention provides.

In the event that the visitor or user does not have an account, the individual may select a link 210 which opens page 300 where the user may create an account and provide details about the user. Such may include entering login information, such as email address 302, creating a password 304, and personal details, such as name 306, phone number 308 and title or management level 310, such as owner, C-suite, director, manager, etc. Additional information may be added, such as the business Employer Identification Number (EIN).

Depending upon the type of user, whether it be an invoice holder/seller, a factoring company or a customer, additional information may be provided. For example, an invoice seller may create an account which includes the seller profile. This may include, for example, the invoice seller inputting factoring service requirements or factoring companies to review in the future to see if they meet the requirements of the invoice seller. Once the user has inputted all of the required and/or additional information, the user presses the continue button 314 to login to the system.

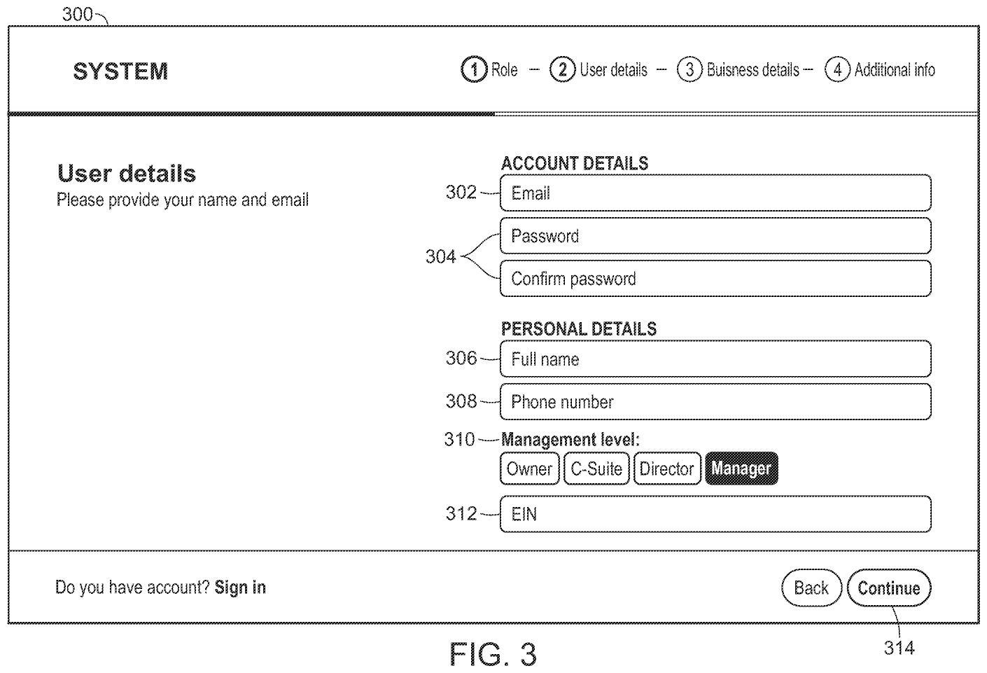

It will be appreciated by those skilled in the art that the entry of information indicated above with respect to FIGS. 2 and 3 are done via an electronic computerized device, such as a desktop computer, laptop, portable computerized electronic device such as a computerized tablet, smartphone or the like. Information may be inputted using a keyboard, virtual keyboard, stylus, voice recognition or the like. This is done via an electronic network, such as the internet or other network which enables the user to remotely access the computerized online marketplace of the present invention, which is typically housed on a server, cloud server or other computerized device which is capable of being accessed through the network. In accordance with the present invention, in a particularly preferred embodiment, all of the interactions and dealings between the various industry professionals, whether they be invoice holders/sellers, factoring companies, customers, etc. are conducted through the computerized online marketplace of the present invention. Thus, after creating an account and logging in, such industry professionals are able to access the computerized online marketplace of the present invention and conduct business therein.

More particularly, the system and method of the present invention allows certain industry professionals who are looking to factor their invoices to shop for specific services by accessing the computerized online marketplace, creating an account, and creating a user profile. Factoring companies can also access the online computerized marketplace, create an account, and create a factoring company profile, in order to search and review profiles, including factoring service requirements of users on the system.

Upon finding eligible candidates for their services, a factoring company, who sets up an account through the online computerized marketplace, can quickly and easily send a digital proposal to one or more user members for their review and action. The negotiation on terms occurs completely on the digital platform and once terms are agreed upon, the factoring company member can digitally send platform initiated legal documents to the user member for execution. These legal documents may include an auto-populated financial disclosure form, currently required pursuant to California law (also being considered by several other states), which is a first-in-industry compliance measure. When an eligible invoice is ready, the user member can digitally upload an invoice into the platform for review and funding by their factoring company member partner.

Tracking the associated invoice status, invoice aging and invoice reserves related to any factored invoice and factoring transaction occurs via the digital platform and its multi-level notification system. The entire platform of the present invention creates a system of transparency for the invoice seller and factoring company so that the transaction processes are updated in real time and information sharing occurs simultaneously. In addition, since payment(s) from a factoring company to an invoice seller, as well as payments on an open invoice from an invoice customer to a factoring company, occurs on the digital platform through an integrated payment program, tracking of real time financial data related to a factoring transaction is also pre-built into the user dashboards. This allows users on both ends of the transaction to properly organize their engagement, transaction and invoice histories, including all communications, documents and data connected thereto, within their digital accounts. Combined with simultaneous data exchange, this creates an unprecedented model of transparency that will change both expectations and outcomes for all users (both invoice sellers and factoring companies) alike.

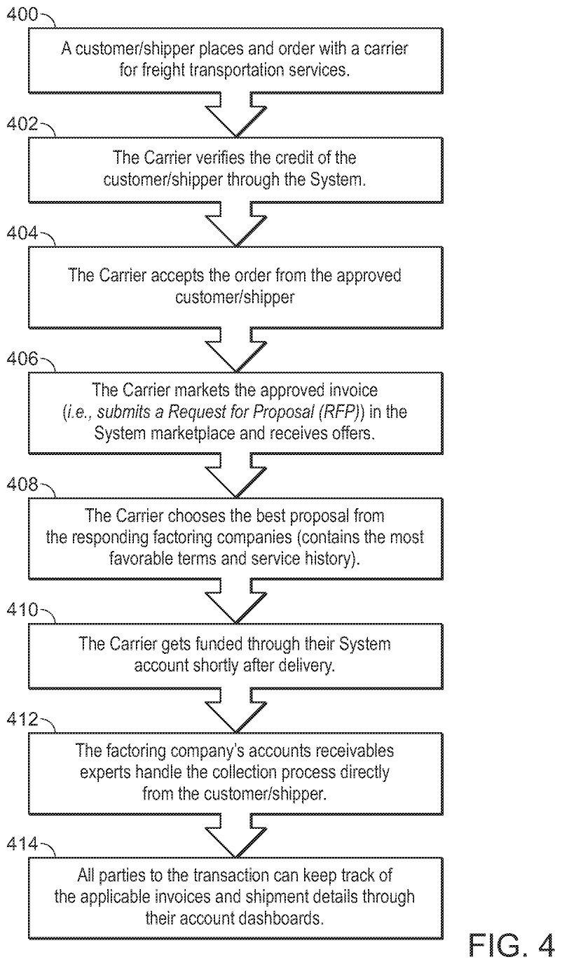

With reference now to FIG. 4, a flowchart is shown depicting steps taken in accordance with the present invention. The flow chart of FIG. 4 describes the steps taken in accordance with the present invention in relation to the freight transportation services industry, for which the present invention is particularly well suited. However, it will be understood that similar steps will be taken in connection with other industries which may use the present invention, which may include, but are not limited to, construction companies, employment staffing organizations, manufacturing activities, etc. A customer places an order with a carrier for freight transportation services (400). The carrier may verify the credit of the customer (402). The carrier accepts the order from the approved customer or shipper (404). The customer/shipper may become a member and access the present invention by creating an account. If the customer/shipper is a member of the system of the present invention, the order may be placed with the carrier (who will become the invoice holder/seller) through the marketplace system of the present invention. If the carrier (invoice holder/seller) is already a member of the system of the present invention, the carrier may verify the credit of the customer/shipper through the system and accept the order of the approved customer/shipper through the system. However, it is contemplated by the present invention that these steps might occur outside of the computerized marketplace system of the present invention, with the carrier, who has become an invoice holder and who desires to sell the invoice, to then become a member of the computerized marketplace after these events have already occurred.

Either before or shortly after delivery, the carrier (invoice holder) becomes a member and markets the invoice in the marketplace system and receives proposals from factoring company members of the platform (406). This is done by submitting a request for proposal (or by clicking on a button to enter the marketplace after the relevant user profile is completed) within the marketplace of the present invention. In accordance with the present invention, such offers may be received in a very short period of time, such as within a few days, in less than a day, or potentially even only hours or minutes after submitting the request for proposal. After its profile is included in the open and searchable marketplace, the invoice seller member (i.e., a carrier in the context of freight transportation, as depicted) may receive multiple proposals from a number of factoring companies. The invoice seller member chooses the best proposal from the responding factoring companies (408), which proposal will likely contain the most favorable terms and be connected with the factoring company holding the best service history, amongst other things.

Acceptance by a carrier member of a proposal from a factoring company member will allow the factoring company member to initiate a digital agreement package, which may be based on smart contract principles. This may be done automatically via clicking control mechanisms on a user dashboard, thereby digitizing a previously manual process while still complying with terms and conditions which are either common in the industry or which have been previously accepted and agreed to by the user member and the factoring company member. Such digital agreements may also potentially be created between user members and invoice customers, who initiate the transaction underlying the invoice itself.

Once the parties' legal relationship has been established, the method for financing specific invoices can occur. Thus, after completion of a transaction, and after the resulting invoice is uploaded by a user member through the system of the present invention, the factoring company member will have the opportunity to review the invoice and determine whether to approve it for financing, whereby it becomes a factored invoice. If so, the user member obtains the funds applicable to the sale/purchase of the invoice directly into their account via on platform ACH or wire transfer by the factoring company member (410). The factoring company member's accounts receivables team then handles the collection process directly by communicating to the invoice customer who initiated the transaction underlying the invoice (412). All parties to the transaction can keep track of the applicable invoices and payment details through their account dashboards (414).

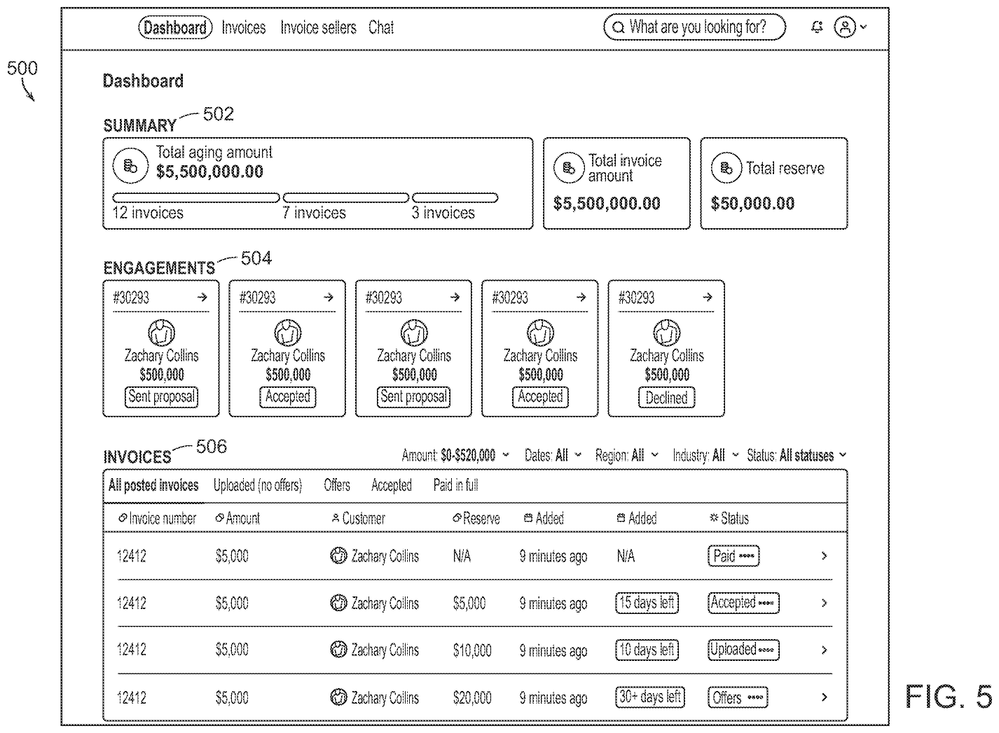

With reference now to FIGS. 5-14, illustrations of exemplary dashboard screens or windows, and related modules, are shown. Such dashboards are accessible to all registered members, including invoice sellers and factoring companies. Such dashboards provide registered members of the system of the present invention various pieces of information, modules, including communication modules, proposal panels, ability to upload and view various documents, including invoices, factored invoices, and legal documents, as well as the status of current engagements and factored invoices. The system of the present invention may provide notifications through such dashboards relating to updates between parties, payment of invoices, etc.

With reference now to FIG. 5, an exemplary window which may form an account dashboard, is shown. The dashboard illustrated in FIG. 5 would apply to an invoice seller member, such as a carrier in the context of a freight transportation transaction, wherein the carrier member may post requests for proposals, review requests for proposals, review offers from factoring companies on the posted requests for proposals, post and view invoices, proof of work completed, bill of lading, etc. The system of the present invention enables the carrier, or other member, to search for desired information or documents, such as invoice numbers, customer identities, or other information related to each post or proposal, which may be pulled up through its dashboard. The member will be able to engage in platform communications, i.e., chat, with factoring company member partners, in order to clarify or correct ambiguities in an ongoing invoice purchase transactions. Typically, a member will have an ongoing relationship with a factoring company, thus allowing a single digital agreement package to be utilized as the basis for, and governing terms of, multiple invoice sale/purchase transactions.

More particularly, with continuing reference to FIG. 5, the dashboard 500 is displayed on an electronic screen of the member's computerized device. The dashboard provides various pieces of information and features and interactivity, wherein the member may select and open various sub-windows, panels, modules, etc. The dashboard 500 illustrated in FIG. 5 is an invoice seller main dashboard which may provide a summary panel 502 with invoice classifications and on-demand ageing display, wherein the invoice seller can immediately view the age of various factored invoices. Panel 502 may include total invoice amounts and total reserves. The dashboard 500 may also include an engagement module 504, wherein the invoice seller member may click through to specific engagement information relating to various factored invoices, relationships with one or more factoring companies, etc. An invoices module 506 enables the invoice seller member to click through to specific invoice information, such as by invoice number, customer name or other identification, and providing various pieces of information relating to the status of invoices, such as whether they have been paid, accepted, the age of the invoice, etc.

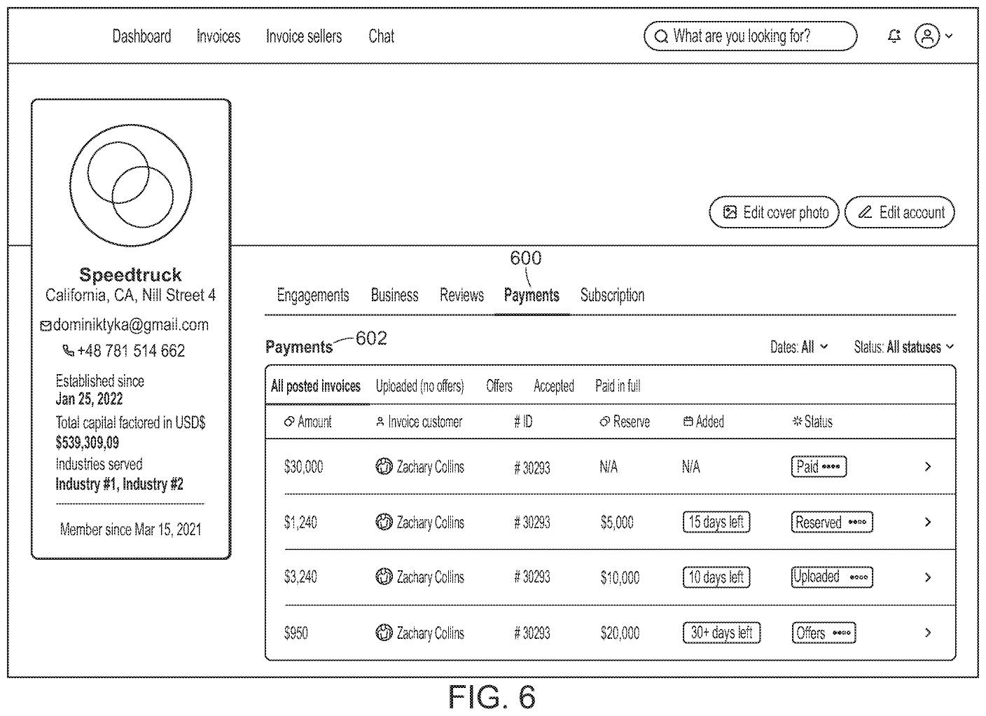

With reference now to FIG. 6, a payment module 600 is shown with an invoice seller's dashboard account. When selecting the “payments” button or link 600, a list of payments may be provided 602, which lists the posted invoices by amount, invoice customer, identification number, reserve, date, status, etc. The user may select a date range or all dates, and a particular status or all statuses of all invoice payments.

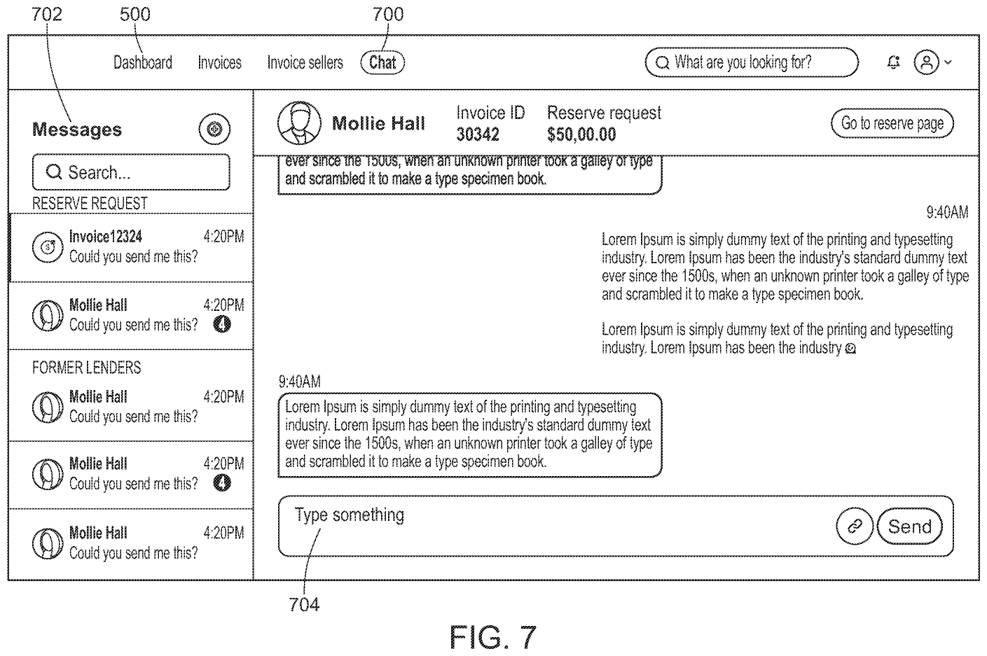

With reference now to FIG. 7, when selecting the “chat” feature 700 from the user's dashboard, a chat module within the invoice seller account is displayed. This may include a communication module, in which messages 702 may be searched, selected, displayed, and messaging 704 between various other parties, such as a factoring company, may take place.

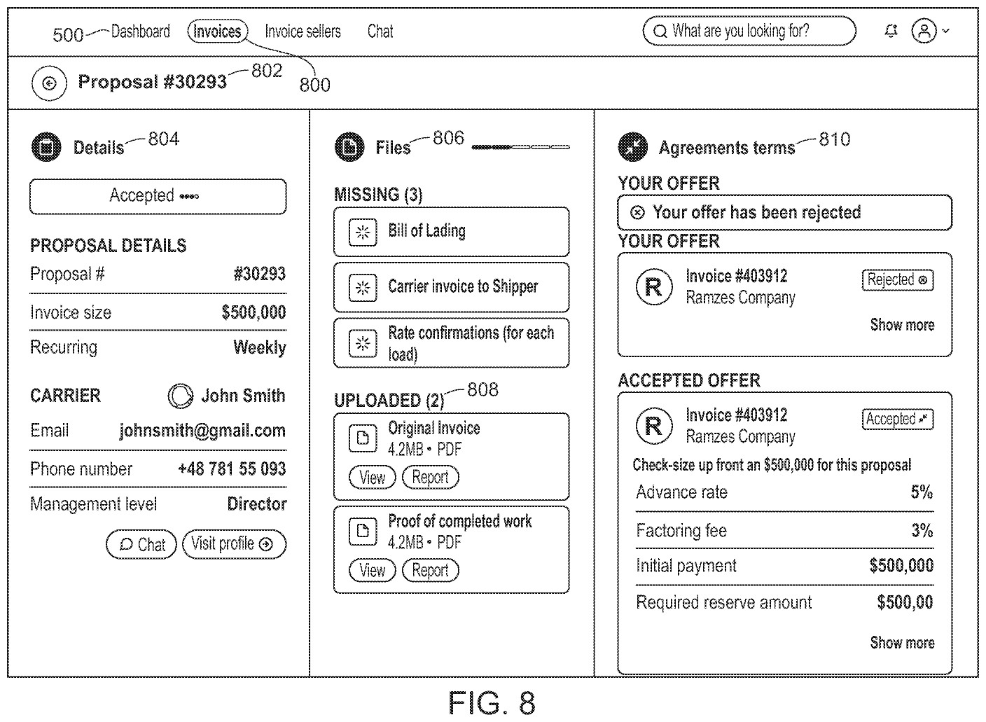

With reference now to FIG. 8, within the invoice seller member's dashboard 500, the member may select the invoices tab 800, which opens an invoice proposal panel, as illustrated in FIG. 8, in which a proposal 802 may be selected, and the details of the proposal 804 are listed, such as whether the proposal has been accepted yet, the details of the proposal, the invoice size, the carrier, information relating to the carrier or invoice seller or customer, various files 806, including a bill of lading, carrier invoice to shipper, rate confirmations for each load, uploaded original invoices 808, proof of completed work, an agreement terms module or window 810, including the invoice seller or factoring companies' offer, counter-offers, accepted offers and the like.

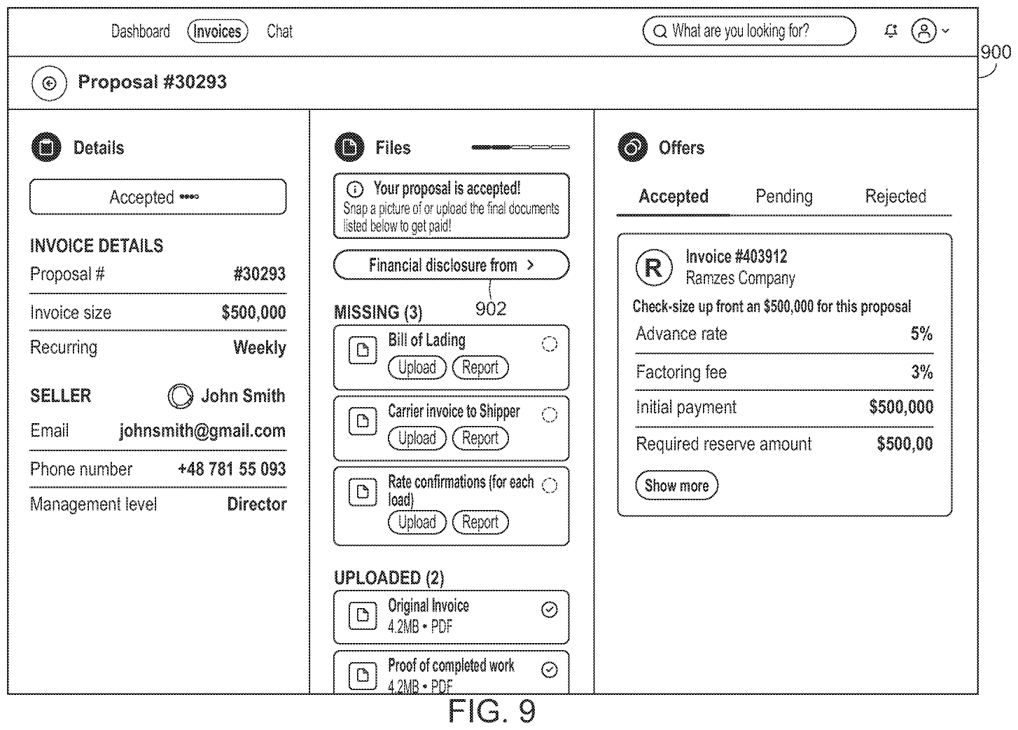

With reference now to FIG. 9, an invoice proposal panel 900 is shown, with proposal details and on-platform digital interface between an invoice seller and a factoring company. These may include whether the proposal has been accepted, invoice details, files relating to the arrangement, offers that have been accepted, pending or rejected, etc. When a proposal is accepted between the invoice seller and the factoring company, a financial disclosure form 902 may be accessed for the creation of one or more legal documents, such as a Financial Disclosure form, which is California compliant, or other legal documents relating to the factoring arrangement between the factoring company and the invoice seller. Such documents may be auto-populated and formed based on information provided by the factoring company and/or invoice seller. The invoice seller and the factoring company may execute the one or more legal documents with digital signatures through the computerized factoring marketplace system of the present invention. All parties to an engagement or transaction may agree to binding digital arbitration, such as via eJudicate, in the event of disputes arising from the transaction.

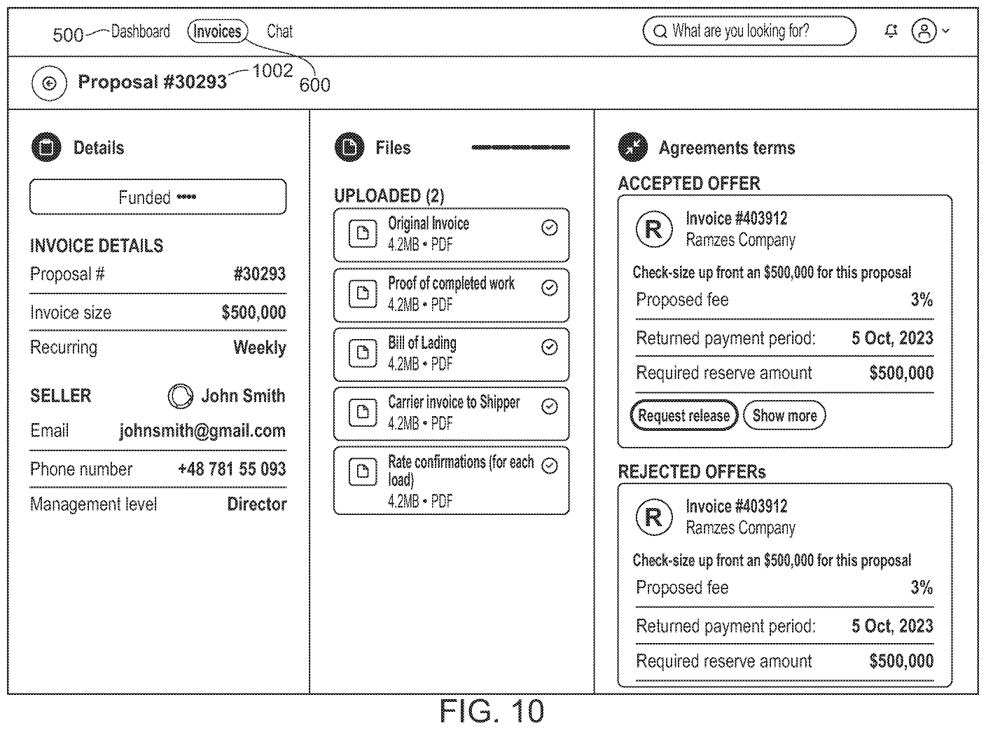

With reference now to FIG. 10, on the member's dashboard 500, the invoice tab 600 may be selected and a particular proposal 1002 may be selected to provide invoice information with respect to that proposal 1002. This may include invoice specifics, related files, agreement terms and release request functions, etc.

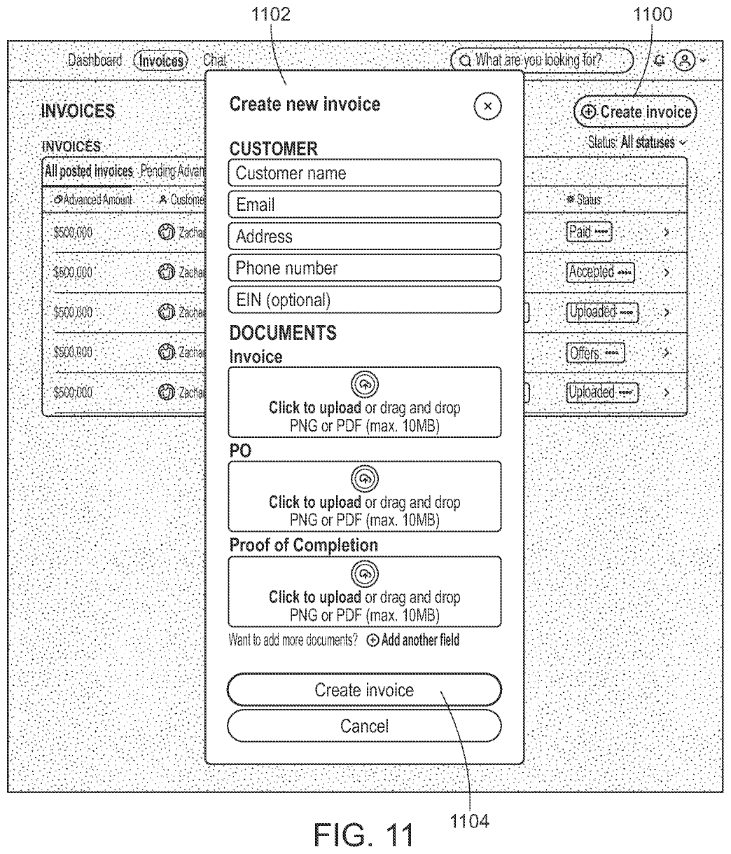

With reference to FIG. 11, from the invoice seller's or other member's dashboard, the “create invoice” button 1100 may be selected so as to open a new window for the creation of a new invoice 1102. Such window 1102 may comprise a new invoice funding request panel, which may include information relating to a customer, documents, such as uploading or dragging and dropping documents, including invoices, purchase orders, proof of completion, etc. after which information is added the user can press the create invoice button 1104 to create the invoice. The user may add additional fields, add additional documents, or even cancel the invoice before it is created.

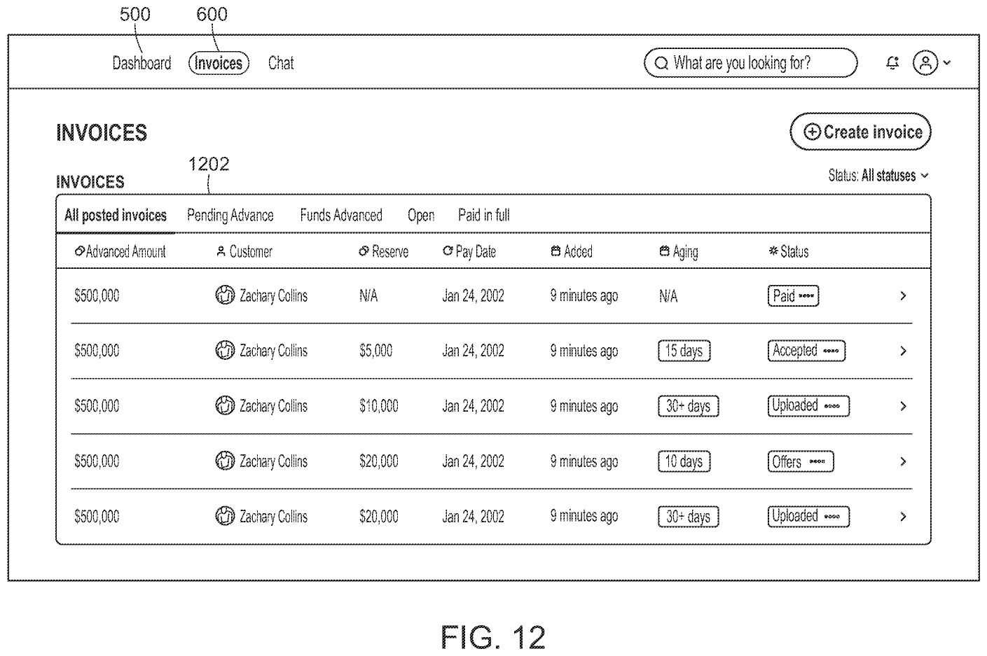

With reference now to FIG. 12, at the user's dashboard 500, when selecting the invoice 600 module, an invoice module may be presented 1202 which lists various invoices and their status. Such statuses may include a specific view with categorical information such as reserve amount, ageing, payment status, etc. The user may select individual invoices to obtain a more full record or accounting of the information relating to that particular invoice.

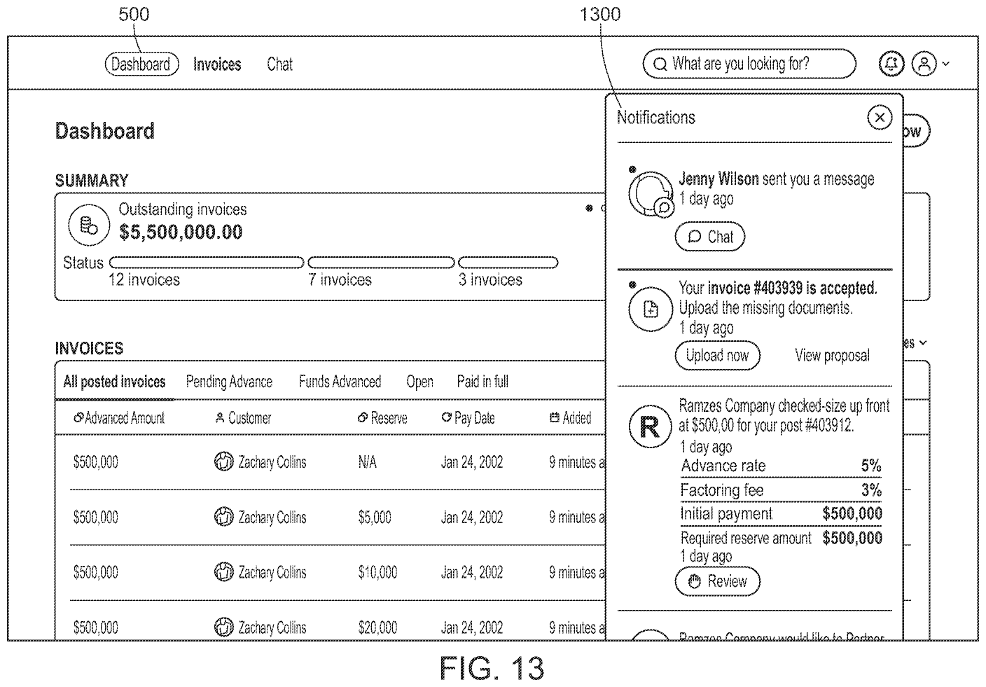

With reference now to FIG. 13, when on the dashboard 500, a user may receive notifications from the system, such as a popup window 1300 which provides such notifications. The notifications may include indications of messages from other members, such as an invoice seller or factoring company, whether invoices or proposals have been accepted or rejected, payments, ages of invoices, etc.

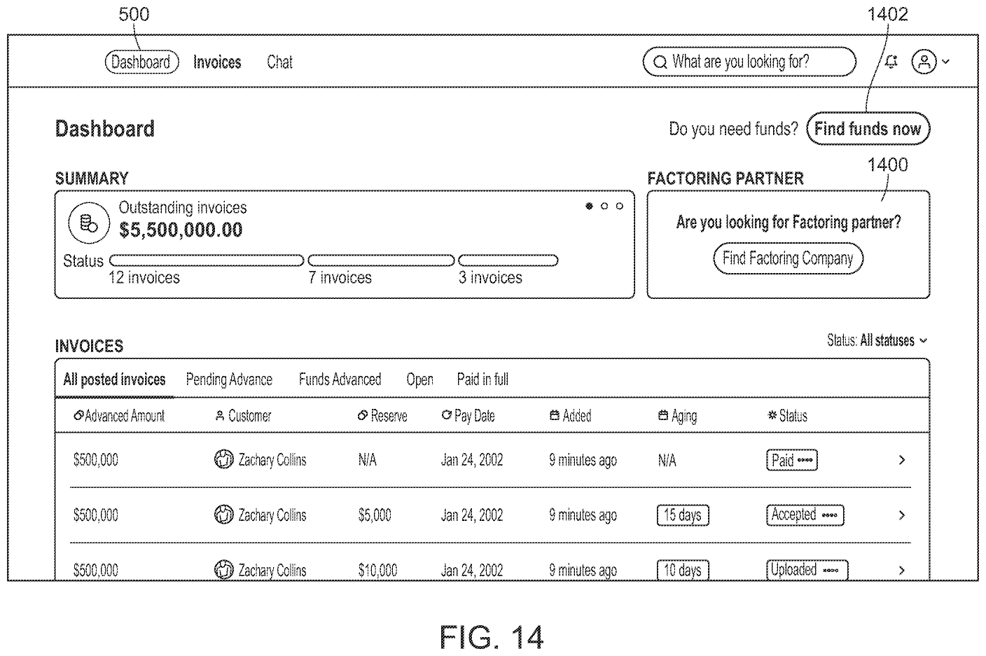

With reference now to FIG. 14, on the invoice seller's dashboard 500 the invoice seller member may be presented with an entry portal for finding a factoring partner 1400, such as finding a factoring company, or to find funds 1402. Clicking or otherwise selecting these options 1400 and/or 1402 may open up other windows or modules, wherein the invoice seller, for example, may upload requests for proposals, upload invoices to be factored, other requests, etc.

The system and method of the present invention also enables uploading of recurring invoices into the system and tracks the evolving status of platform factored invoices. Further, since payment(s) from a factoring company to an invoice seller, as well as payments on an open invoice from an invoice customer to a factoring company, occurs on the digital platform through an integrated payment program, tracking of real time financial data related to a factoring transaction is also pre-built into the parties' dashboards. This allows parties on both ends of the transaction to properly organize their engagement, transaction and invoice histories, including all communications, documents and data connected thereto, within their digital accounts. Combined with simultaneous data exchange, this creates an unprecedented model of transparency that will change both expectations and outcomes for all parties (both invoice sellers and factoring companies) to a factoring transaction.

Payment of funds, such as through a payment module, on the accounts receivable invoice by the factoring company member partner triggers its entitlement to payment on the applicable invoice, in accordance with the terms of the parties' digital agreement package. In the event of non-payment by the invoice customer, then after a predetermined period of time, such as ninety days, the invoice purchase price may be charged back to the user member if the factoring agreement was a recourse agreement.

The present invention may incorporate tools allowing members to monitor invoice payment details for accurate chargeback and reserve credit allocations. This may be useful in resolving disputes before they require legal intervention, though the system of present invention may also incorporate a digital dispute resolution platform to handle routine conflicts without the need to go off platform.

The present invention may require no minimums, no long-term contracts for upper tier members having high scores, such as due to a long history as a member, excellent reputation, etc.

The system and method of the present invention provides efficiency, agility, technology implementation and digital safeguards, focused communication on transaction related matters, digitally enhanced organization and tracking of transaction details, clarity of term execution, ease of use leading to potential reduction in staffing levels and other cost savings.

The present invention may utilize artificial intelligence applications to generate a score for user members and factoring company members, so that additional underwriting criteria can be utilized by all platform members to determine risk associated with any given engagement/transaction.

Additional incentives or elements to the system of the present invention may include partnering with peripheral service providers to give members discounts on service provider required items, such as fuel, tires, trucks, etc., in the context of freight transportation. The present invention also contemplates offering an insurance marketplace as part of the platform. The platform of the present invention may be utilized to advertise and generate additional revenue from the variety of users, including the invoice customers, factoring companies, etc.

The online marketplace system and method of the present invention allows invoice sellers to create business and invoice profiles. The present invention allows invoice sellers to solicit proposals directly from active factoring companies regarding their factoring services within an online platform. Factoring companies, on the other hand, can navigate and browse invoice seller profiles in order to determine whom they wish to submit proposals to.

The system of the present invention enables automated creation of the factoring security agreement and other related legal documents, and thus, documents are able to be signed digitally within the platform to legalize the parties' transaction. Invoices are uploaded into the system, submitted for factoring company review/acceptance, and factored invoices are tracked via platform tools.

Although several embodiments have been described in detail for purposes of illustration, various modifications may be made without departing from the scope and spirit of the invention. Accordingly, the invention is not to be limited, except as by the appended claims.

What is claimed is:

1. A process for invoice factoring, comprising the steps of:
providing a computerized factoring marketplace;
a factoring company accessing the factoring marketplace via an electronic network using a computerized device and creating an account;
an invoice seller accessing the factoring marketplace via an electronic network using a computerized device and creating an account, including an invoice seller profile, and requesting a factoring proposal;
the factoring company reviewing the request for factoring proposal through the factoring marketplace, and creating a digital factoring proposal sent to the invoice seller through the computerized factoring marketplace;
the invoice seller and the factoring company agreeing to a factoring arrangement; and
tracking, via the factoring marketplace, the status, including payment and/or aging of the one or more factored invoices subject to the factoring arrangement.

2. The process of claim 1, including the step of the invoice seller and the factoring company communicating and negotiating terms of the factored arrangement through the computerized factoring marketplace.

3. The process of claim 1, automatically generating at least one legal document, accessible by the factoring company and the invoice seller through the computerized factoring marketplace, relating to the agreed to factoring arrangement between the factoring company and the invoice seller.

4. The process of claim 3, including the step of the invoice seller and the factoring company executing the at least one legal document with digital signatures through the computerized factoring marketplace.

5. The process of claim 4, wherein the step of automatically generating the at least one legal document includes the step of auto-populating a financial disclosure form based on information provided by the factoring company and/or invoice seller.

6. The process of claim 1, including the step of a customer accessing the computerized factoring marketplace via an electronic network using a computerized device to review the factored invoice, communicate with the factoring company and/or pay the factored invoice.

7. The process of claim 1, wherein the invoice seller creating an account step includes the step of the invoice seller inputting factoring service requirements.

8. The process of claim 1, wherein the tracking step includes the step of updating in real time factored invoice transactions or deadlines and automatically notifying the factoring company and invoice seller of updates.

9. The process of claim 6, including the step of providing through the computerized factoring marketplace a payment system accessible by the factoring company, invoice seller, and customer to make payments on the factored invoice or factoring arrangement and to provide payment notifications.

10. The process of claim 1, including the step of providing a digital dashboard for each factoring company and invoice seller that enables access to transaction data related to factored invoices and factoring arrangements.

11. The process of claim 1, including a plurality of factoring companies each creating digital proposals, and the invoice seller reviewing and selecting a factoring company proposal through the computerized factoring marketplace.

12. The process of claim 1, including the steps of the invoice seller uploading one or more digital invoices and the factoring company determining whether to approve one or more of the digital invoices for financing.

13. The process of claim 1, including the step of automatically refunding a factoring purchase price to the factoring company if the factored invoice is not paid after a predetermined period of time under a recourse arrangement between the invoice seller and the factoring company.

14. The process of claim 1, including the step of providing digital dispute resolution between the invoice seller and the factoring company through the computerized factoring marketplace.

15. The process of claim 1, including the step of allowing third parties to offer goods or services to the invoice seller or factoring company through the computerized factoring marketplace.

16. The process of claim 1, including the step of generating a reliability score for the invoice seller and/or factoring company.
